(19) United States
(12) Patent Application Publication
(10) Pub. No.: US 2026/0036336 A1
(43) Pub. Date: Feb. 5, 2026

(54) AN ELECTRICALLY HEATED APPARATUS AND A METHOD OF HEATING A FLUID

(71) Applicant: SHELL USA, INC., Houston, TX (US)

(72) Inventor: Govert Gerardus Pieter VAN DER PLOEG, Amsterdam (NL)

(21) Appl. No.: 18/995,392

(22) PCT Filed: Aug. 2, 2023
(86) PCT No.: PCT/EP2023/071439

§ 371 Date: Jan. 16, 2025

(30) Foreign Application Priority Data
Aug. 9, 2022 (EP) 22189392.8

(51) Int. Cl. F24H 9/18; B01J 19/24; F24H 9/02

(52) U.S. Cl. CPC F24H 9/18; B01J 19/2415; F24H 9/02; B01J 2219/00135; F24H 2250/02

(57) ABSTRACT

In a heating space of an electrically heated apparatus, elongate electrical radiative heater elements, which each stretch between a proximal end and a distal end of each elongate electrical radiative heater element, are mechanically secured to a wall peripheral to the heating space. The electrically heated apparatus can be used in methods of heating a fluid.

The present invention relates to an electrically heated apparatus, in particular for heating fluids at high temperatures and high thermal intensity. Heating of fluids comprising reactants may be part of performing an endothermic gas conversion reaction.

Electrically heated reactors are known in the art. For example, US 2016/0325990 A1 describes an electrically heated steam reforming reactor having electric resistance heating elements vertically suspended in sanitary unions through a top flange. The heating elements can be removed and replaced.

One drawback associated with the steam reforming reactor of US 2016/0325990 A1 is that the vertical height of the heated area is effectively limited to the length of the individual heating elements.

In accordance with a first aspect of the invention, there is provided an electrically heated apparatus, comprising:
a furnace housing comprising at least one wall positioned between a top and a base, which at least one wall, the top, and the base together enclose a heating space;
at least one tube arranged within said heating space and having an inlet and an outlet outside of the heating space, for passing a fluid to be heated from the inlet through the at least one tube to the outlet;
at least a first elongate electrical radiative heater element stretching between a proximal end and a distal end of the first elongate electrical radiative heater element, wherein said first elongate electrical radiative heater element is mechanically supported by said at least one wall whereby at least said distal end is within the heating space.

In accordance with a second aspect of the invention, there is provided a method of heating a fluid using the electrically heated apparatus provided in the first aspect, wherein the method comprises at least the steps of:
a) feeding a feed stream comprising said fluid via the inlet of the at least one tube;
b) supplying an electrical current to the at least the first elongate electrical radiative heater element in the heating space of the apparatus;
c) exposing the tube to radiation heat originating from at least the first elongate electrical radiative heater element in the heating space of the apparatus, thereby adding heat to the fluid;
d) discharging an effluent stream from the apparatus via the outlet of the at least one tube.

In case the fluid contains reactants, the heating of the fluid may be accompanied by an endothermal conversion reaction and the effluent stream may in such cases comprise one or more reaction products.

Although not limited thereto, the method according to the present invention is in particular intended for heating fluids and/or performing fluid conversion reactions in large scale applications (involving 50 MW or more of electric heating power).

Hereinafter the present invention will be further illustrated by the following non-limiting drawing.

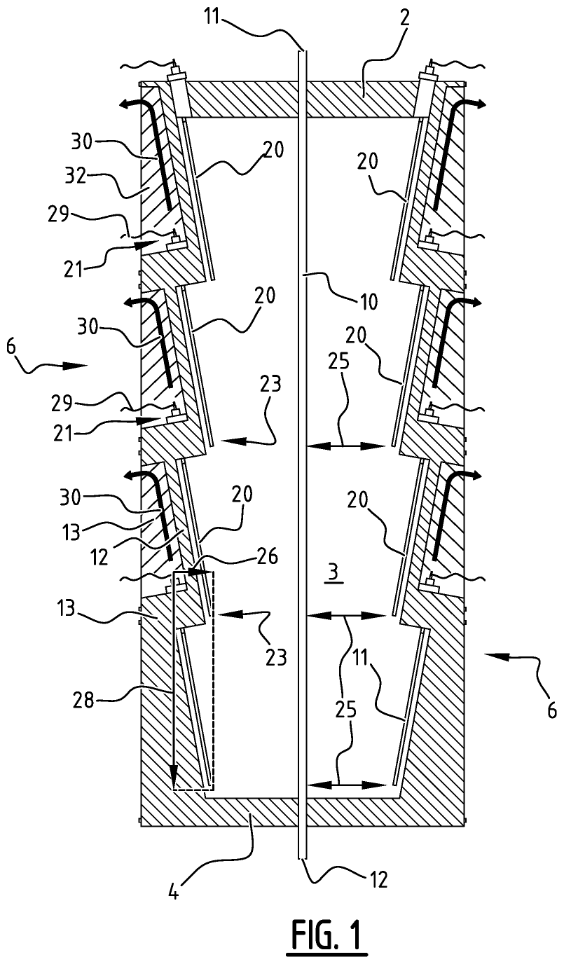

FIG. 1 schematically shows a cross-sectional view though two opposing walls of an electrically heated apparatus;

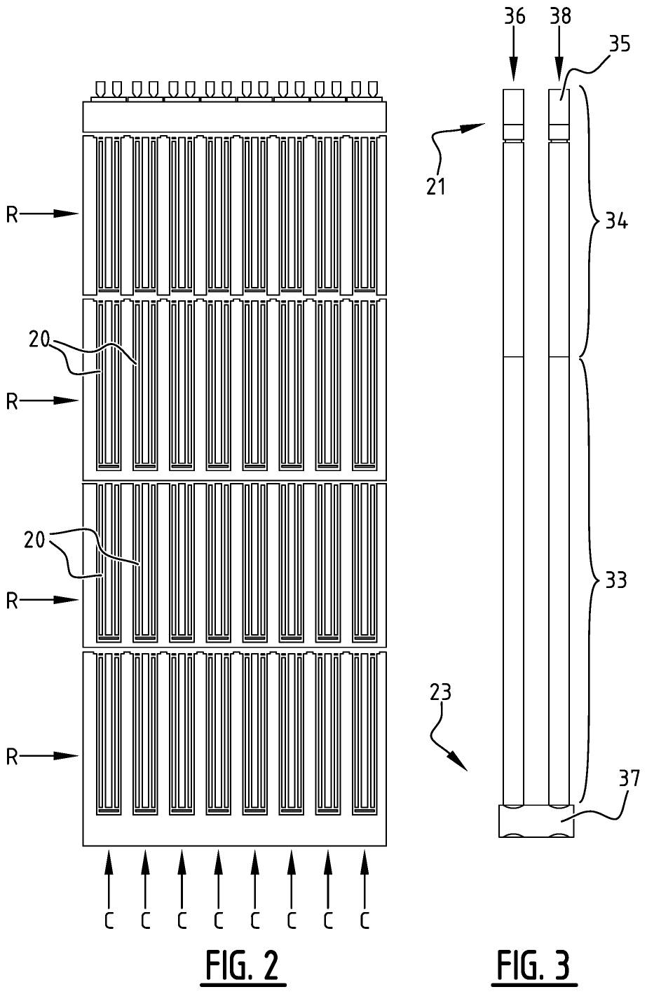

FIG. 2 schematically shows a view of one of the walls of the electrically heated apparatus of FIG. 1 from the inside of the heating space; and

FIG. 3 schematically shows a frontal view of an elongate electrical radiative heater element used in FIG. 1.

For the purpose of this description, same reference numbers refer to same or similar components.

According to the present proposal, the elongate electrical radiative heater elements, which each stretch between a proximal end and a distal end of each elongate electrical radiative heater element, are mechanically secured to a wall peripheral to the heating space.

Herewith it achieved that the heater elements can be positioned at any desired vertical height within the heating space. This way, the heater elements can be (much) shorter than the internal height of the heating space while it is still possible to expose lower sections of the process fluid tube(s) within the heating space to radiation from the electric heating elements. By placing a plurality of heating elements at different heights, the heating elements collectively can heat the tube(s) over the full length of the tube(s) whilst the length of each tube is typically longer than the length of the separate heating elements.

Furthermore, the elongate electrical radiative heater elements may advantageously extend, as seen from the proximal end, in a direction having non-zero vertical and horizonal components. I.e., each of the elongate electrical radiative heater elements may be directed non-vertically, at an angle between vertical and horizontal. This has various benefits. Firstly, if the wall on which the elongate electrical radiative heater elements are secured is essentially a vertically extending side wall, the angled direction relative to the essentially vertical side wall facilitates reaching the proximal end of a selected one of the elongate electrical radiative heater elements from the outside of the electrically heated apparatus, without the need to access the elongate electrical radiative heater elements from the heating space. Secondly, the angled direction relative to vertical allows for multiple elongate electrical radiative heater elements to be secured in a vertical array (column) in a roof-tile fashion, whereby the distal end of one of the elongate electrical radiative heater elements is located between the process fluid tube(s) and the proximal end of a vertically neighbouring one of the elongate electrical radiative heater elements. Herewith, so-called dead zones (or cold zones) in the heating arrangement, caused by gaps between vertically adjacent elongate electrical radiative heater elements can be avoided.

The elongate electrical radiative heater elements could point downwards, whereby the distal end of any selected elongate electrical radiative heater element is lower than its proximal end; or they could point upwards, whereby the distal end of any selected elongate electrical radiative heater element is higher than its proximal end. An advantage of the downward orientation is that the elongate electrical radiative heater elements can be supported by layer of refractory material on the side of the elongate electrical radiative heater elements which faces away from the process fluid tube(s). In case of upward orientation, the electrical radiative heater element must be self-supporting and/or a support frame may have to be arranged which as much as possible does not block radiation from the elongate electrical radiative heater elements towards the process fluid tube(s).

Advantageously, the at least one wall comprises a refractory liner separating the heating space from a peripheral space surrounding said refractory liner, whereby the said proximal end of the elongate radiative heating elements extend into the peripheral space. This further enhances the accessibility of the heating elements. The proximal ends are suitably secured to the at least one wall by the refractory liner. It is preferred that the heating elements are removably secured by the wall in such a manner that the heating elements can be replaced.

The electrical radiative heating elements as used in the apparatus according to the present invention can be easily replaced in case of premature failure or aging of the electrical radiative heating elements, without the need for entry (by a person) into the heating space. This may be achieved by temporarily removing an outer protective metal covering, to expose the proximal ends of a number of the heating elements. A service port may also be provided in a direct vicinity to the proximal end of the elongate electrical radiative heaters, through which one or more of the electrical radiative heaters are retractable. This way a selected elongate electrical radiative heater can be serviced or replaced with a relatively small amount of effort.

The electrically heated apparatus may be suitable for supporting endothermic reactions at high temperature (such as above 400° C.) and/or heating fluids to such high temperature. The electrically heated apparatus is suitable for large scale applications requiring electric power of 50 MW or higher. The heating duty may be enhanced by using a plurality of tubes within one heating space. In this specification, the term “fluid” includes any fluidic phase, i.e. vapor phase, liquid phase, supercritical phase, multiphase and it may comprise a single substance or a mixture of multiple substances.

Further, as different regions in the heating space are heated by different heating elements, this allows for a differentiated heating duty profile within the heating space similar to what is disclosed in International publication Nos. WO 2020/002326 A1 and WO 2021/130107 A1. The apparatus according to the present invention may provide a precise temperature control of the tubes and the fluids flowing through the tubes.

A further advantage of the present invention is that the principle thereof can also be applied to existing apparatuses, by making the appropriate adaptions. The invention can be retrofitted into existing fuel fired furnaces to electrify the operation thereof.

The person skilled in the art will readily understand that the electrically heated apparatus can vary widely and may comprise several additional elements. As the person skilled in the art is familiar with how to design an electrically heated apparatus, this is not discussed here in detail.

The apparatus of the present disclosure comprises an electrically heated furnace having a top cover and walls, which together with a bottom, define a heating space. The walls, top cover and bottom of this furnace typically comprise some refractory and insulation to avoid undue heat leakage to outside of the furnace. The electrically heated furnace may be provided with some non-electrical heating (other than provided as the result of an exothermic reaction), but preferably at least 50%, preferably at least 80%, most preferably all, of the heating is provided by electrical heating.

The at least one tube (but typically several tubes) running through the heating space may be varied widely, provided that the tube have an inlet and outlet outside of the space. As a mere example, the tubes do not have to be straight (although preferred), but may have e.g. a S-or U-shape. In the event that U-shaped tubes are used, both the inlet and the outlet of the tubes may be at one side (e.g. at the top). If several tubes are present, then the tubes preferably run substantially parallel. The tubes may generally be referred to with the term ‘process fluid tubes’. In case the apparatus is in the form of a reactor (and hence not merely used for heating), the tubes can optionally be referred to with ‘reactor tubes’. The tubes maybe in the form of a coil, i.e. spirally shaped.

The electrical radiative heating elements (located in the heating space) should be elongate so that they can be pulled though any service opening. Preferably, the electrical radiative heating elements are also rigid. Typically, for the heating of the electrical radiative heating elements, electric resistance heating is used (which makes use of the ‘Joule effect’). Generally, the electrical radiative heating elements are suited to be heated to a temperature above 300° C. Preferably, the electrical radiative heating elements are suited to be heated to a temperature in the range of from 400°° C. to 1600° C. Preferably, the electrical radiative heating elements comprise resistance heating elements based on NiCr, SiC, and/or FeCrAl.

The person skilled in the art will readily understand that the electrical radiative heating elements can take many different shapes including rods and plates. The electrical radiative heating elements can be self-supporting or supported on an external structure such as for example (ceramic) rods with heating wire or sheets wrapped around the rods, etc.

Although the heating elements can have many forms, it is especially preferred that the electrical radiative heating elements are embodied by rods. Examples of suitable tubular heating elements are silicon carbide (SiC) rods. These are commercially available, for example from Kanthal GmbH, Mörfelden-Walldorf, Germany, under the brand name Kanthal®. Such tubular SiC heating elements allow a compact design of the furnace space to be achieved. Preferred SiC heating elements are multi-leg elements which have all the electric connectors at the proximal end.

Typically, the length of the heating elements is smaller than the length of the tube(s) and/or the internal height of the heating space. The current proposal offers a solution to this length difference. Several rows of heating elements may be employed one above another, to heat the tube(s) over the full length of the tube(s) and/or the entire height of the heating space.

According to a preferred embodiment, the apparatus comprises at least ten tubes running through the heating space. Preferably, the tubes run substantially parallel to each other. Furthermore, it is preferred that the tube(s) extend in a substantially vertical manner. In such a vertical set-up of the tubes, it is preferred that the fluids flowing through the tubes flow downwards. Thus, in that case the inlet of the tubes is at the top and the outlet at the bottom.

To avoid undue overheating of the tubes it is preferred that the electrical radiative heating elements are not in direct contact with the tubes. In other words, the heating elements and the tubes do not touch each other, at least not in the heating space. It is preferred that the horizontal separation between the tubes and the distal ends of the elongate radiative heating elements within a single column is approximately constant.

FIG. 1 shows a schematic cross sectional view of an electrically heated apparatus. This may be a reactor, but it may also be used for (only) heating fluids, i.e. without a reaction taking place.

The apparatus of FIG. 1 comprises: a top cover 2, a base 4, and walls 6 around the periphery of a heating space 3. The walls 6 may be side walls. The walls 6 may, as a whole, extend (substantially or truly) vertically. A plurality of process fluid tubes 10 (only one being visible in FIG. 1) and a plurality of electrical radiative heating elements 20 are arranged within the heating space 3. Each heating element 20 has a proximal end 21 and a distal end 23. The distal end 23 of each electrical radiative heater element 20 is positioned within the heating space 3.

The walls 6 comprise a refractory liner 12 for thermal insulation. The refractory liner 12 may be, at least in part, supported by a steel structure (not shown) via anchoring. The refractory liner 12 may be made of light weight refractory material, refractory bricks, or a combination of both. In the example as shown, the refractory liner 12 has a saw-tooth contour with slanted L-shaped sections, stacked on top of each other in generally vertical direction. The refractory liner 12 generally separates the heating space 3 from a peripheral space surrounding the refractory liner 12.

With the optional exception of the top row of electrical heating elements, the proximal ends 21 of the remainder of the electrical heating elements 20 extend into the peripheral space surrounding the refractory liner 12. As a result, these proximal ends 21 can be reached relatively easily from the outside of the heating space 3, for servicing or replacing. The heating elements 20 are preferably removably secured. In this case, the heating elements 20 penetrate through bores provided in support sections 13 of the refractory liner 12, which correspond to the short legs of the slanted L sections. Also, electrical wiring 29 may be connected to the heating elements 20 at the proximate ends 21 of the heating elements 20.

As seen from the proximal end 21, each heating element 20 extends into the heated space 3 in a direction having non-zero vertical and horizonal components. (The horizontal component is schematically indicated in FIG. 1 by arrow 26 and the vertical component by arrow 28.) I.e. the heating element 20 is arranged at an angle from the vertical of between 0° and 90°, not including the end points of this range. Preferably, the non-zero vertical component 28 is larger than the non-zero horizontal component 26, ensuring that the heating elements 20 do not reach too far into the heating space 3, thereby saving lateral plot space. A ratio between the non-zero horizontal component and the non-zero vertical component is preferably smaller than 0.6 (corresponding to smaller than about 31° included angle between the vertical and the direction of the elongate heater element), more preferably smaller than 0.5 (corresponding to smaller than about 27° included angle between the vertical and the direction of the elongate heater element). The smaller angles are preferred, to minimize gravitational bending forces on the heater elements, which could break them.

Heating elements 20 can extend into the heating space 3 from different heights. As visible in FIG. 2, several heating elements 20 may be provided on any single wall, in horizontal adjacency to each other (rows R). Furthermore, the heating elements 20 may be grouped in vertical arrays (columns C), each of which comprising two or more of the heating elements 20. When observed from the side, such as in FIG. 1, the heating elements 20 within a single vertical array may be arranged in a roof-tile arrangement, whereby vertically successive heating elements 20 are partly overlapping with each other. The heating elements 20 within one such vertical array may suitably extend in directions that are parallel to each other. It is preferred that the ratio between the non-zero horizontal component 26 and the non-zero vertical component 28 is larger than 0.02 (corresponding to an included angle between the vertical and the direction of the elongate heater element of larger than about) 1°, preferably larger than 0.05 (corresponding to an included angle between the vertical and the direction of the elongate heater element of larger than about) 2.5° and most preferably larger than 0.1 (corresponding to an included angle between the vertical and the direction of the elongate heater element of larger than about) 5°. The minimum angle relates with the space needed for a proximal end of a further heating element to be stacked underneath the distal end of one of the other heating elements provided on the same wall.

In the present example, one wall comprises 4 rows R and 8 columns C of double-legged heating elements 20. However, the invention is not limited to any particular number of rows, columns, or legs.

As can be seen in FIG. 1, the tubes 10 run through the heating space 3 and have an inlet 11 and outlet 12 outside of the heating space 3. Further, the tubes 10 extend in a substantially vertical manner. The electrical radiative heating elements 20 are not in direct contact with the tubes 10. The horizontal separation 25 between the tube(s) 10 and the distal ends 21 of the elongate radiative heating elements 20 within a single column C is approximately constant. This is attributable to the essentially vertical stacking of the individual heating elements in a column.

In the event of premature failing or aging of the electrical radiative heating elements 20 while being used in the heating apparatus 1, these heating elements can be easily replaced without entry by a person into the heating space 3 being required. This is schematically illustrated by arrows 30. The space included between the long and short legs of the slanted L-shaped sections may suitably be filled with removable blocks 32 of (preferably, lightweight) refractory material to supplement the refractory material provided in the long legs of the slanted L-shaped sections. These blocks may be removed when servicing the heating elements 20. This can be done after or during removing of any (metal) covering, which may also be present (not shown) in the walls 6, surrounding the refractory liner 12. By maintaining an under pressure in the heating space 3, the escape of hot air though the bores in which the heating elements are mounted.

FIG. 3 shows a close up frontal view of the elongate electrical radiative heater element 20 as can be used in embodiments described above. It comprises two rods 36 and 38 or SiC, arranged parallel side by side to each other at a predetermined non-contacting distance from each other. An electrically conducting connection 37 is provided between the two rods in the distal end 23. This way, electric current can be fed at the proximal end 21 of one of the rods and pass through both rods to be direct out via the proximal end of the other one of the pair of rods.

As indicated in FIG. 3, the rods have a hot zone 33 and a cold end 34, which comprises the proximal end 21. The cold end 34 is preferably of sufficient length to traverse the support sections 13 of the refractory liner and/or any other mounting elements. The hot zone 33 including the distal end 23 are fully exposed, and, when the heating element is properly secured in the refractory liner, protrude into the heating space.

At the proximal end 21, the cold end 34 of each rod is further provided with a metallic or otherwise high conducting material. In this case, the material was spray coated aluminium. Further details of these particular heating elements, as well as mounting instructions, can be found in a Kanthal brochure “Silicon Carbide Heating Elements—Globar® SD” published May 2018.

During use of the heating apparatus, a fluid stream (typically a gas) is fed via the inlets 11 into the tubes 10. The fluid stream flowing through the tubes 10 is then subjected to heating by radiation emitted from the electrical radiative heating elements 20 and being absorbed by the tube(s). In case of the fluid containing one or more reactants, the heating may drive an endothermal chemical conversion reaction, thereby obtaining one or more reaction products. Subsequently, an effluent stream is discharged from the tubes via the outlets 12. The effluent stream may contain the one or more reaction products, or it may be merely a heated fluid stream.

The person skilled in the art will readily understand that the nature of the fluid conversion reaction is not particularly limited. Non-limiting, but preferred examples are SMR (Steam Methane Reforming), steam cracking, etc. The person skilled in the art will readily understand that many modifications may be made without departing from the scope of the invention.

1. An electrically heated apparatus, comprising:
a furnace housing comprising at least one wall positioned between a top and a base, wherein the at least one wall, the top, and the base together enclose a heating space:
at least one tube arranged within said heating space and having an inlet and an outlet outside of the heating space, for passing a fluid to be heated from the inlet through the at least one tube to the outlet:
at least a first elongate electrical radiative heater element stretching between a proximal end and a distal end of the first elongate electrical radiative heater element, wherein said first elongate electrical radiative heater element is mechanically secured to said at least one wall whereby at least said distal end is within the heating space.

2. The electrically heated apparatus of claim 1, wherein the wall comprises a refractory liner separating said heating space from a peripheral space surrounding said refractory liner, and wherein the said proximal end extends into the peripheral space.

3. The electrically heated apparatus of claim 2, wherein the proximal end is secured to the at least one wall by the refractory liner.

4. The electrically heated apparatus of claim 1, whereby the first elongate electrical radiative heater element extends, as seen from the proximal end, in a first direction having non-zero vertical and horizonal components.

5. The electrically heated apparatus of claim 4, wherein the non-zero vertical component is larger than the non-zero horizontal component.

6. The electrically heated apparatus of claim 4, wherein a ratio between the non-zero horizontal component and the non-zero vertical component is in a range of between 0.02 and 0.6.

7. The electrically heated apparatus claim 1, further comprising at least a second elongate electrical radiative heater element stretching between a proximal end of the second elongate electrical radiative heater element and a distal end of the second elongate electrical radiative heater element, wherein said second elongate electrical radiative heater element is mechanically secured to said at least one wall whereby at least said distal end of the second elongate electrical radiative heater element is within the heating space, and wherein the proximal end of the second elongate electrical radiative heater element is located either higher or lower than the proximal end of the first elongate electrical radiative heater element.

8. The electrically heated apparatus of claim 4, whereby the second elongate electrical heater element extends, as seen from the proximal end of the second elongate electrical radiative heater element, in a second direction having non-zero vertical and horizonal components.

9. The electrically heated apparatus of claim 8, wherein the first direction is parallel to the second direction.

10. The electrically heated apparatus of claim 8, wherein the proximal end of the second elongate electrical radiative heater element is vertically above or below the proximal end of the first elongate electrical radiative heater element.

11. The electrically heated apparatus of claim 1, wherein the first elongate electrical radiative heater element comprises two rods arranged parallel side by side to each other at a predetermined non-contacting distance from each other, whereby in the distal end of said elongate electrical radiative heater element comprises an electrically conducting connection between the two rods.

12. The electrically heated apparatus claim 1, wherein said wall comprises a service port in a direct vicinity to the proximal end of the first elongate electrical radiative heater, through which the at least one elongate electrical radiative heater is retractable.

13. A method of heating a fluid using the electrically heated apparatus according to claim 1, wherein the method comprises at least the steps of:
a) feeding a feed stream comprising said fluid via the inlet of the at least one tube;
b) supplying an electrical current to the at least the first elongate electrical radiative heater element in the heating space of the apparatus;
c) exposing the tube to radiation heat originating from at least the first elongate electrical radiative heater element in the heating space of the apparatus, thereby adding heat to the fluid;
d) discharging an effluent stream from the apparatus via the outlet of the at least one tube.
